(19) United States
(12) Patent Application Publication
(10) Pub. No.: US 2013/0248305 A1
(43) Pub. Date: Sep. 26, 2013

(54) CARBON-CERAMIC BRAKE DISK AND METHOD FOR MANUFACTURING SAME

(71) Applicants: Yeonho Choi, Jeonju-si (KR); Hyunkyu Shin, Changwon-si (KR); Junsang Lee, Seoul (KR); Chaewook Cho, Daejeon (KR); Jungsuk Kang, Jeonju-si (KR); Dongwon Im, Gimhae-si (KR); Byunggun Chea, Jeonju-si (KR); Moonsoo Choi, Jeonju-si (KR)

(72) Inventors: Yeonho Choi, Jeonju-si (KR); Hyunkyu Shin, Changwon-si (KR); Junsang Lee, Seoul (KR); Chaewook Cho, Daejeon (KR); Jungsuk Kang, Jeonju-si (KR); Dongwon Im, Gimhae-si (KR); Byunggun Chea, Jeonju-si (KR); Moonsoo Choi, Jeonju-si (KR)

(73) Assignee: DACC CO., LTD., Changwon (KR)

(21) Appl. No.: 13/990,116

(22) PCT Filed: Nov. 28, 2011
(86) PCT No.: PCT/KR2011/009130

§ 371 Date: May 29, 2013

(30) Foreign Application Priority Data
Nov. 29, 2010 (KR) 10-2010-0119416

(51) Int. Cl. F16D 65/12

(52) U.S. Cl. CPC F16D 65/126
USPC 188/218 XL; 427/227

(57) ABSTRACT

A method of manufacturing a carbon-ceramic brake disc of the present invention includes a first step of mixing carbon fibers with phenolic resins to produce a mixture; a second step of putting the mixture into a mold pressing the mixture by a press to produce a molded body; a third step of carbonizing the molded body; a fourth step of machining the carbonized molded body; a fifth step of coating the machined molded body with liquid-phase phenol to be cured; a sixth step of melting silicon to be infiltrated into the cured molded body that has been coated with the liquid-phase phenol; and a seventh step of grinding the molded body that has been infiltrated by the silicon. According to present invention, the cracks do not occur in the anti-oxidation coating layer.

### TECHNICAL FIELD

The present invention relates to a carbon-ceramic brake disc.

### BACKGROUND ART

A vehicle brake is classified into a drum brake and a disc brake. The disc brake reduces a speed of a vehicle or stops the vehicle by slowing and stopping rotation of the disc due to frictional force caused by friction between a surface of the disc and a pad. The disk having a high level of braking ability needs to be light in weight and to have high heat resistance, high impact resistance, high oxidation resistance and high wear resistance. In addition, the disk needs to have high strength and a high friction coefficient. To achieve this, the disc has been recently manufactured using carbon-fiber-reinforced ceramic composites.

The carbon-fiber-reinforced ceramic composites are carbon-fiber-reinforced materials using ceramic matrixes.

Hereinafter, the brake disc manufactured using carbon-fiber-reinforced ceramic composites is referred to as a carbon-ceramic brake disc.

Meanwhile, the carbon-ceramic brake disc includes a carbon component. Accordingly, when a temperature of the carbon-ceramic brake disc is equal to or higher than 320° C., a surface of the carbon-ceramic brake disc exposed to an atmosphere may be easily oxidized. Particularly, an outer peripheral surface where outlets of cooling channels of the carbon-ceramic brake disc are located may be further easily oxidized. This is because heat generated in the carbon-ceramic brake disc is mostly released to the outside through the outlets of the cooling channels and a temperature of the outer peripheral surface is especially high. The oxidation is easily performed at a high temperature.

In order to solve the problem, a surface of the carbon-ceramic brake disc has been conventionally coated with a suspension including an oxidation inhibitor.

Examples of the oxidation inhibitor included in the suspension include a boron compound (B, B₂O₃, ZrB₂, B₄c, or the like) and a phosphorus compound (POCl₃, P₂O₅, B₃PO₄, or the like). When the surface of the carbon-ceramic brake disc is coated with the suspension, an anti-oxidation coating layer is formed on the surface of the carbon-ceramic brake disc. The anti-oxidation coating layer prevents the surface of the carbon-ceramic brake disc from being oxidized by being in contact with air.

A method of coating the surface of the carbon-ceramic brake disc with the suspension is as follows.

The surface of the carbon-ceramic brake disc is brushed with the suspension by a brush, is sprayed with the suspension, or is dipped into and taken out of a container filled with the suspension, and is then repeatedly heat-treated at 300° C. to 1200° C. By doing this, the anti-oxidation coating layer is formed on the surface of the carbon-ceramic brake disc. The anti-oxidation coating layer includes hyaline compound components or crystalline inorganic compound components. Meanwhile, the oxidation inhibitor (the boron compound and the phosphorus compound) included in the suspension is crystallized to be cured as time elapses. The cured anti-oxidation coating layer is easy to be desquamated. In addition, it takes a long time to repeatedly perform heat treatment at the temperature of 300° C. to 1200° C.

As another method, ceramic precursors are vaporized at a temperature of 1100 to 1500° C. to be deposited on the surface of the carbon-ceramic brake disc through chemical vapor deposition. By doing this, the anti-oxidation coating layer is formed on the surface of the carbon-ceramic brake disc. Methyltrichlorosilane (MTS) is used as the ceramic precursor. Such a ceramic precursor is expensive. Further, during the formation of the anti-oxidation coating layer, harmfulness gas (HCl) is generated. Moreover, it is difficult to waste a by-product (NaCl) from the process.

In addition, when the anti-oxidation coating layer is formed on the surface of the carbon-ceramic brake disc by the aforementioned methods, due to a difference between thermal expansion coefficients of the carbon-ceramic brake disc and the anti-oxidation coating layer, cracks occur in the anti-oxidation coating layer. Air comes in contact with the carbon-ceramic brake disc through the cracks, and thus the carbon-ceramic brake disc may be oxidized. Further, it is necessary to additionally perform a process of forming the anti-oxidation coating layer on the surface of the carbon-ceramic brake disc other than the process of manufacturing the carbon-ceramic brake disc.

### DETAILED DESCRIPTION OF THE INVENTION

### Technical Problem

An object of the present invention is to provide a carbon-ceramic brake disc having high oxidation resistance and a method of manufacturing the same. Further, another object of the present invention is to provide a method of simply manufacturing a carbon-ceramic brake having high oxidation resistance.

### Technical Solution

In order to achieve the above object, there is provided a method of manufacturing a carbon-ceramic brake disc including a first step of mixing carbon fibers with phenolic resins to produce a mixture; a second step of putting the mixture into a mold to produce a molded body through pressing by means of a press; a third step of carbonizing the molded body; a fourth step of machining the carbonized molded body; a fifth step of coating the machined molded body with liquid-phase phenol to be cured; a sixth step of melting silicon to be infiltrated into the cured molded body that has been coated with the liquid-phase phenol; and a seventh step of grinding the molded body that has been infiltrated by the silicon.

Further, the objects are achieved by a carbon-ceramic brake disc including an anti-oxidation coating layer formed on a surface thereof, in which the anti-oxidation coating layer includes silicon filling cracks to remove the cracks and silicon carbide generated in portions where the cracks do not occur.

Furthermore, the objects are achieved by a method of manufacturing a carbon-ceramic brake disc including a first step of mixing carbon fibers with phenolic resins to produce a first mixture and a second mixture; a second step of putting the first mixture into a mold to produce a first molded body through pressing by means of a press and putting the second mixture into the mold to produce a second molded body through pressing by means of the press; a third step of carbonizing the first molded body and the second molded body; a fourth step of machining the carbonized first molded body and second molded body; a fifth step of allowing the machined first molded body and the machined second molded body to adhere to each other; a sixth step of coating the first molded body, the second molded body, and an adhering portion between the first molded body and the second molded body that have adhered to each other to be cured; a seventh step of melting silicon to be infiltrated into the first molded body, the second molded body, and the adhering portion between the first molded body and the second molded body that have been cured after coated with the liquid-phase phenol; and an eighth step of grinding the first molded body and the second molded body that have been infiltrated by the silicon.

Moreover, the objects are achieved by a carbon-ceramic brake disc including a supporting layer; a friction layer that adheres to upper and lower surfaces of the supporting layer; an adhesive layer that is formed between the supporting layer and the friction layer; and an anti-oxidation coating layer that is formed on a surface of the supporting layer, a surface of the friction layer, and a surface of the adhesive layer, in which the anti-oxidation coating layer includes silicon filling cracks to remove the cracks and silicon carbide generated in portions where the cracks do not occur.

In addition, the objects are achieved by a method of manufacturing a carbon-ceramic brake disc including a first step of mixing carbon fibers with phenolic resins to produce a first mixture and a second mixture; a second step of putting the first mixture into a mold to produce a first molded body through pressing by means of a press and putting the second mixture into the mold to produce a second molded body through pressing by means of the press; a third step of carbonizing the first molded body and the second molded body; a fourth step of machining the carbonized first molded body and second molded body; a fifth step of coating the machined first molded body with liquid-phase phenol to be cured; a sixth step of allowing the cured first molded body after coated with the liquid-phase phenol and the machined second molded body to adhere to each other; a seventh step of melting silicon to be infiltrated into the first molded body and the second molded body that have adhered to each other; and an eighth step of grinding the first molded body and the second molded body that have been infiltrated by the silicon.

Further, the objects are achieved by a carbon-ceramic brake disc including a supporting layer; a friction layer that adheres to upper and lower surfaces of the supporting layer; an adhesive layer that is formed between the supporting layer and the friction layer; and an anti-oxidation coating layer that is formed on a surface of the supporting layer, in which the anti-oxidation coating layer includes silicon filling cracks to remove the cracks and silicon carbide generated in portions where the cracks do not occur.

Furthermore, the objects are achieved by a method of manufacturing a carbon-ceramic brake disc including a first step of mixing carbon fibers with phenolic resins to produce a first mixture and a second mixture; a second step of putting the first mixture into a mold to produce a first molded body through pressing by means of a press and putting the second mixture into the mold to produce a second molded body through pressing by means of the press; a third step of carbonizing the first molded body and the second molded body; a fourth step of machining the first molded body and the second molded body; a fifth step of allowing the machined first molded body and the machined second molded body to adhere to each other; a sixth step of coating only the first molded body of the first molded body and the second molded body that have adhered to each other to be cured; a seventh step of melting silicon to be infiltrated into the cured first molded body that has been coated with the liquid-phase phenol; and an eighth step of grinding the first molded body and the second molded body that have been infiltrated by the silicon.

### Advantageous Effect

According to the present invention, in the step of melting the silicon to be infiltrated into the cured portion, cracks formed on the cured portion that has been coated with the liquid-phase phenol is are filled with the silicon to be removed.

Therefore, there are no cracks on an anti-oxidation coating layer which is formed during the step of melting the silicon to be infiltrated into the cured portion.

Accordingly, since the air does not come in contact with the surface of the carbon-ceramic brake disc through the cracks, the surface of the carbon-ceramic brake disc is not oxidized, so that it is possible to obtain the carbon-ceramic brake disc having high oxidation resistance. In addition, according to the present invention, during the manufacturing of the carbon-ceramic brake disc, the anti-oxidation coating layer is formed. Thus, it is not necessary to additionally perform a process of forming the anti-oxidation coating layer other than the process of manufacturing the carbon-ceramic brake disc.

Moreover, according to the present invention, during the manufacturing of the carbon-ceramic brake disc, the anti-oxidation coating layer is formed. Thus, the anti-oxidation coating layer is firmly connected to the carbon-ceramic brake disc.

In addition, according to the present invention, since the anti-oxidation coating layer includes silicon and silicon carbide, it is possible to obtain the anti-oxidation coating layer having high strength.

### DESCRIPTION OF DRAWINGS

FIG. 1 is a flowchart illustrating a method of manufacturing a carbon-ceramic brake disc according to a first embodiment of the present invention.

FIG. 2(a) is a diagram illustrating that a mixture is put into a mold.

FIG. 2(b) is a diagram illustrating that the mixture is pressed by a press to produce a molded body.

FIG. 2(c) is a diagram illustrating that the molded body is taken out of the mold.

FIG. 3 is a diagram illustrating a state where cracks occur in the cured portion that has been coated with the liquid-phase phenol in the sixth step of FIG. 1.

FIG. 4 is a diagram illustrating a state where the cracks illustrated in FIG. 3 are filled with the silicon to remove the cracks.

FIG. 5 is a diagram showing a carbon-ceramic brake disc manufactured by the method of manufacturing a carbon-ceramic brake disc according to the first embodiment of the present invention.

FIG. 6 is a flowchart illustrating a method of manufacturing a carbon-ceramic brake disc according to a second embodiment of the present invention.

FIG. 7(a) is a diagram illustrating that a first mixture is put into a mold.

FIG. 7(b) is a diagram illustrating that the first mixture is pressed by a press to produce a first molded body.

FIG. 7(c) is a diagram illustrating that the first molded body is taken out of the mold.

FIG. 8(a) is a diagram illustrating that a second mixture is put into a mold.

FIG. 8(b) is a diagram illustrating that the second mixture is pressed by a press to produce a second molded body.

FIG. 8(c) is a diagram illustrating that the second molded body is taken out of the mold.

FIG. 9 is a diagram illustrating a carbon-ceramic brake disc manufactured by the method of manufacturing a carbon-ceramic brake disc according to the second embodiment of the present invention.

FIG. 10 is a flowchart illustrating a method of manufacturing a carbon-ceramic brake disc according to a third embodiment of the present invention.

FIG. 11 is a diagram illustrating a carbon-ceramic brake disc manufactured by the method of manufacturing a carbon-ceramic brake disc according to the third embodiment of the present invention.

FIG. 12 is a flowchart illustrating a method of manufacturing a carbon-ceramic brake disc according to a fourth embodiment of the present invention.

### EMBODIMENTS FOR CARRYING OUT THE INVENTION

Hereinafter, a method of manufacturing a carbon-ceramic brake disc according to a first embodiment of the present invention will be described.

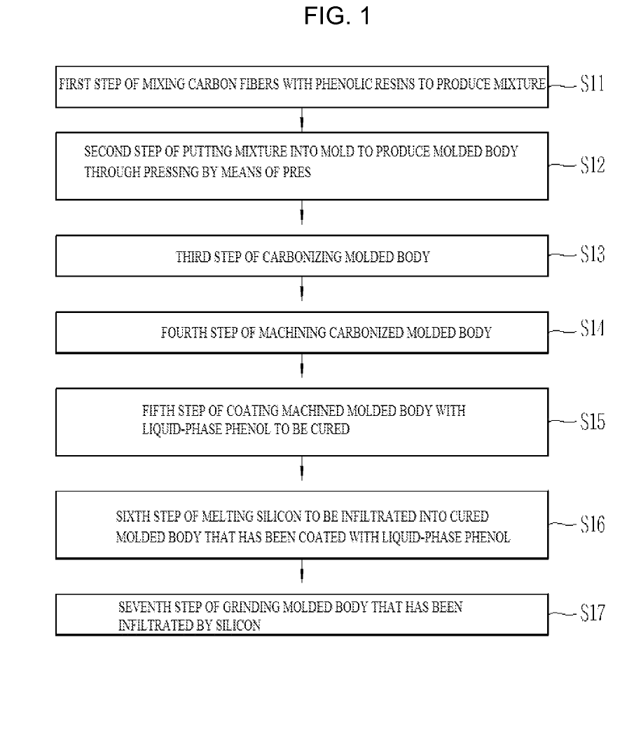

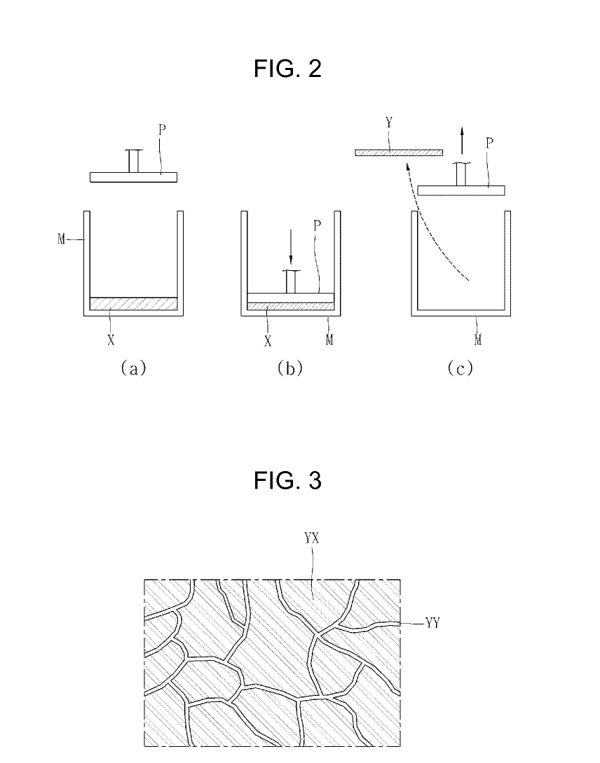

FIG. 1 is a flowchart illustrating a method of manufacturing a carbon-ceramic brake disc according to a first embodiment of the present invention. FIGS. 2(a), 2(b), and 2(c) are diagrams illustrating a procedure of manufacturing a molded body by using a mixture. Solid-line arrow shown in FIGS. 2(a), 2(b), and 2(c) represents a direction where a press moves, and dotted-line arrow represents a direction where the molded body is taken out of a mold.

As shown in FIGS. 1, 2(a), 2(b) and 2(c), the method of manufacturing a carbon-ceramic brake disc according to the first embodiment of the present invention includes first step S11 of mixing carbon fibers with phenolic resins to produce a mixture X by; second step S12 of putting the mixture X into a mold M to produce a molded body Y through pressing by means of a press P; third step S13 of carbonizing the molded body Y; fourth step S14 of machining the carbonized molded body Y; fifth step S15 of coating the machined molded body Y with liquid-phase phenol and curing the molded body; sixth step S16 of melting silicon to be infiltrated into the cured molded body Y that has been coated with the liquid-phase phenol; and seventh step S17 of grinding the molded body Y that has been infiltrated by the silicon.

Hereinafter, first step S11 will be described.

Carbon fibers of 30 to 70 vol % and phenolic resins of 70 to 30 vol % are mixed to each other to produce the mixture X.

Next, second step S12 will be described.

As shown in FIG. 2(a), the mixture X is put into the mold M.

As shown in FIG. 2(b), the mixture X is pressed by a press P to produce a molded body Y. At this time, the pressing pressure is in a range of 3 to 5 MPa. Here, the mixture X may be heated using a heater provided at the press P. The heating temperature is in a range of 120 to 180° C.

As shown in FIG. 2(c), the molded body Y is taken out of the mold M.

The molded body Y is composed of the carbon fibers that are randomly distributed within the cured phenolic resins.

Next, third step S13 will be described.

The molded body Y is put into a crucible. The crucible is put into a vacuum resistance furnace. An atmosphere within the vacuum resistance furnace is a vacuum atmosphere or an inert atmosphere.

The vacuum resistance furnace increases a temperature of the molded body Y to 1550° C. for 13 hours.

The vacuum resistance furnace maintains the temperature of the molded body Y at 1550° C. for 1 to 2 hours.

While the temperature of the molded body Y is increased to 1550° C. and maintained at the increased temperature, organic compounds included in the molded body Y are thermally decomposed to become carbons. Pores are formed in portions generated by the thermal-decomposition of the organic compounds.

Next, fourth step S14 will be described.

An axle hole through which an axle passes is formed in a central portion of the molded body Y.

Through holes through which bolts connected to a hat part pass are formed around the axle hole of the molded body Y at the same interval on a concentric circle. The hat part is connected to a wheel.

Next, fifth step S15 will be described.

The liquid-phase phenol is brushed over a surface of the molded body by a brush, the liquid-phase phenol is sprayed onto the surface of the molded body, or the molded body is dipped into a container filled with the liquid-phase phenol and is then taken out. A coating thickness of the liquid-phase phenol is in a range of 0.1 to 2 mm. The molded body Y that has been coated with the liquid-phase phenol is cured. The curing temperature is 200° C.

The cured portion that has been coated with the liquid-phase phenol becomes an anti-oxidation coating layer after a step of melting silicon to be infiltrated into the molded body is performed.

In the first embodiment, the entire surface of the molded body Y is coated with the liquid-phase phenol. Only an outer peripheral surface of the molded body Y except for upper and lower surfaces thereof may be coated with the liquid-phase phenol, and the anti-oxidation coating layer may be formed on only the outer peripheral surface of the molded body.

When the entire surface of the molded body Y is coated with the liquid-phase phenol, the anti-oxidation coating layer is naturally formed on the upper and lower surfaces of the molded body. After the step of melting silicon to be infiltrated into the molded body is performed, the upper and lower surfaces of the molded body become a frictional surface, and an anti-oxidation coating layer is formed on the frictional surface. In such a case, when a brake is operated, since a pad comes in contact with the anti-oxidation coating layer other than the frictional surface, a braking distance can be further decreased. This is because a friction coefficient (0.48) of the anti-oxidation coating layer is greater than a friction coefficient (0.44) of the frictional surface.

Meanwhile, the molded body Y may be coated with liquid-phase phenol to which carbon powders are added. Volume percent (vol %) of the liquid-phase phenol and volume percent (vol %) of the carbon powders are in the proportion of 2:1. As the carbon powders, carbon powders separated from the molded body Y when machining the molded body may be used.

When the carbon powders are added to the liquid-phase phenol, the number of carbons in the coated portion is increased. For this reason, in the step of melting silicon to be infiltrated into the molded body, the number of carbons reacting with the silicon is increased. Accordingly, the amount of silicon carbide is increased in the coating layer. When the amount of silicon carbide is increased in the coating layer, it is possible to obtain a high-intensity coating layer having a high friction coefficient.

Next, sixth step S16 will be described.

The silicon is put into the crucible.

The molded body Y is put into the crucible so as to allow a lower part of the molded body to be buried in the silicon. An upper part of the molded body Y is covered with the silicon.

The crucible is put into the vacuum resistance furnace. An atmosphere of the vacuum resistance furnace is a vacuum atmosphere or an inner atmosphere.

The vacuum resistance furnace increases a temperature of the molded body Y to 1550° C. for 13 hours.

The vacuum resistance furnace maintains the temperature of the molded body Y at 1550° C. for 1 to 2 hours.

While the temperature of the molded body Y is increased to 1550° C. and maintained at the increased temperature, the silicon is melted to be infiltrated into the pores of the molded body Y.

Most of the silicon infiltrated into the pores reacts with the carbons included in the molded body Y to become silicon carbide (SiC). The pores are filled with the rest of the silicon that does not react with the carbons.

While the temperature of the molded body Y is increased to 1550 to 1600° C. and maintained at the increased temperate, the cured portion that has been coated with the liquid-phase phenol is carbonized.

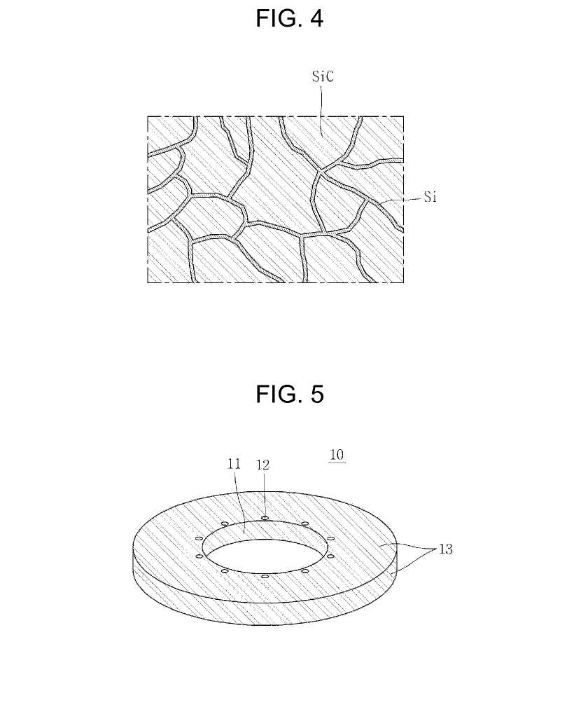

FIG. 3 is a diagram illustrating a state where cracks occur in the cured portion that has been coated with the liquid-phase phenol in the sixth step of FIG. 1. FIG. 4 is a diagram illustrating a state where the cracks illustrated in FIG. 3 are filled with the silicon.

As illustrated in FIG. 3, while the cured portion that has been coated with the liquid-phase phenol is carbonized, cracks YY occur. Portions YX in which cracks do not occur are carbonized.

As illustrated in FIG. 4, the cracks are filled with the silicon. In the portions in which cracks do not occur, the carbons react with the silicon to produce the silicon carbide. Thus, the cured portion that has been coated with the liquid-phase phenol becomes an anti-oxidation coating layer 13 (see FIG. 5).

Next, seventh step S17 will be described.

The molded body Y is ground by a grinder.

FIG. 5 is a diagram showing a carbon-ceramic brake disc manufactured by the method of manufacturing a carbon-ceramic brake disc according to the first embodiment of the present invention.

As shown in FIG. 5, a carbon-ceramic brake disc 10 manufactured by the method of manufacturing a carbon-ceramic brake disc according to the first embodiment of the present invention is formed as a single body. The single body is composed of carbon fibers and ceramic matrixes other than the carbon fibers.

An axle hole 11 through which an axle passes is formed in a central portion of the carbon-ceramic brake disc 10. Through holes 12 through which bolts connected to a hat part pass are formed around the axle hole 11 at the same interval on a concentric circle.

A thickness of the carbon-ceramic brake disc 10 is in a range of 20 to 50 mm

A composition of the carbon-ceramic brake disc 10 includes SiC of 65 to 25 wt %, Si of 15 to 20 wt %, and C of 20 to 50 wt %. The carbon fibers are randomly distributed in the carbon-ceramic brake disc 10. The carbon fiber is formed such that the number of filaments each having a diameter of 7 μm in per bundle is in a range of 1K to 48K. A length of the carbon fiber is in a range of 1 to 30 mm.

As illustrated in FIG. 5, the anti-oxidation coating layer 13 is formed on the entire surface of the carbon-ceramic brake disc 10.

Due to the anti-oxidation coating layer 13 without cracks, air does not come in contact with the surface of the carbon-ceramic brake disc 10. Accordingly, the surface of the carbon-ceramic brake disc 10 is not oxidized.

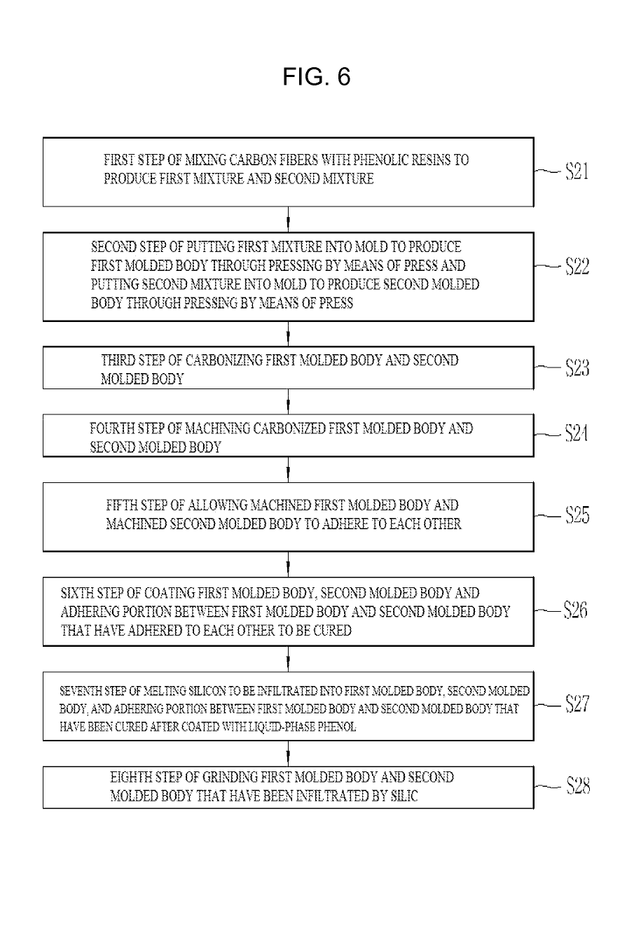

FIG. 6 is a flowchart illustrating a method of manufacturing a carbon-ceramic brake disc according to a second embodiment of the present invention.

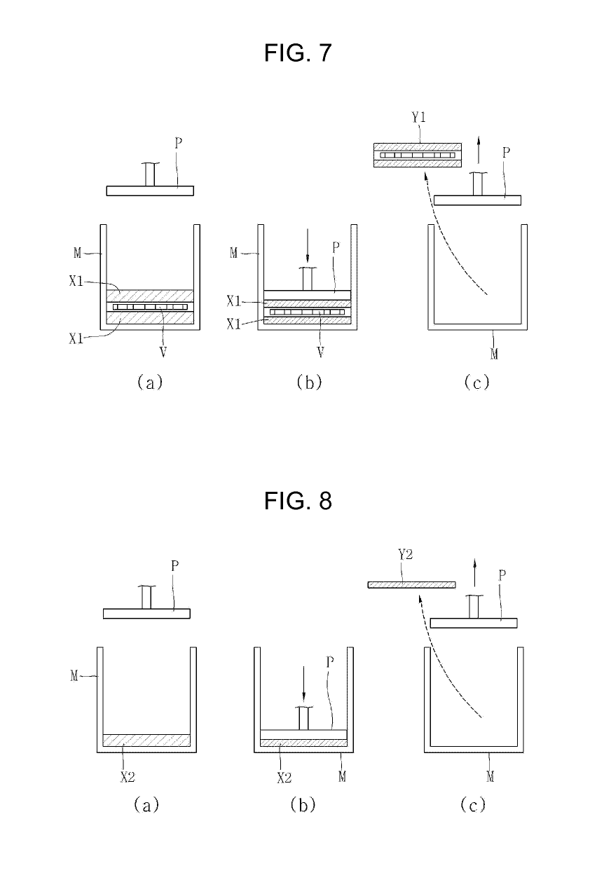

FIGS. 7(a), 7(b), and 7(c) are diagrams illustrating a procedure of manufacturing a first molded body using a first mixture. FIGS. 8(a), 8(b), and 8(c) are diagrams illustrating a procedure of manufacturing a second molded body using a second mixture. Solid-line arrow illustrated in FIGS. 7 and 8 represents a direction where a press moves, and dotted-line arrow represents a direction where the first molded body or the second molded body is taken out of a mold.

As illustrated in FIGS. 6, 7(a), 7(b), 7(c), 8(a), 8(b), and 8(c), the method of manufacturing a carbon-ceramic brake disc according to the second embodiment of the present invention includes first step S21 of mixing carbon fibers with phenolic resins to produce a first mixture X1 and a second mixture X2; second step S22 of putting the first mixture X1 into a mold M to produce a first molded body Y1 through pressing by means of a press P and putting the second mixture X2 into the mold M to produce a second molded body Y2 through pressing by means of the press P; third step S23 of carbonizing the first molded body Y1 and the second molded body Y2; fourth step S24 of machining the carbonized first molded body Y1 and second molded body Y2; fifth step S25 of allowing the machined first molded body Y1 and the machined second molded body Y2 to adhere to each other; sixth step S26 of coating the first molded body Y1, the second molded body Y2, and an adhering portion between the first molded body Y1 and the second molded body Y2 that have adhered to each other to be cured; seventh step S27 of melting silicon to be infiltrated into the first molded body Y1, the second molded body Y2, and the adhering portion between the first molded body Y1 and the second molded body Y2 that have been cured after coated with the liquid-phase phenol; and eighth step S28 of grinding the first molded body Y1 and the second molded body Y2 that have been infiltrated by the silicon.

Hereinafter, first step S21 will be described.

The carbon fibers of 30 to 70 vol % and the phenolic resins of 70 to 30 vol % are mixed to each other to produce the first mixture X1. A support layer to be described below is formed using the first mixture X1.

The carbon fibers of 30 to 70 vol % and the phenolic resins of 70 to 30 vol % are mixed to each other to produce the second mixture X2. A friction layer to be described below is formed using the second mixture X2.

Next, second step S22 will be described.

As illustrated FIG. 7(a), the first mixture X1 is put into the mold M.

A core body V is placed on the first mixture X1. The core body V has a shape of a cooling channel. The first mixture X1 is put on the core body V.

As illustrated in FIG. 7(b), the first mixture is pressed by the press P to produce the first molded body Y1. At this time, the pressing pressure is in a range of 3 to 5 MPa. Here, the first mixture X1 may be heated by a heater provided at the press P. The heating temperature is in a range of 120 to 180° C.

As illustrated in FIG. 7(c), the first molded body Y1 is taken out of the mold M.

The first molded body Y1 is composed of carbon fibers that are randomly distributed within the cured phenolic resins.

As illustrated in FIG. 8(a), the second mixture X2 is put into the mold M.

As illustrated in FIG. 8(b), the second mixture X2 is pressed by the press P to produce the second molded body Y2. At this time, the pressing pressure is in a range of 3 to 5 MPa. Here, the second mixture X2 may be heated by a heater provided at the press P. The heating temperature is in a range of 120 to 180° C.

As illustrated in FIG. 8(c), the second molded body Y2 is taken out of the mold M.

The second molded body Y2 is composed of the carbon fibers that are randomly distributed within the cured phenolic resins.

Next, third step S23 will be described.

The first molded body Y1 is carbonized. The second molded body Y2 is carbonized. A method of carbonizing the first molded body Y1 and the second molded body Y2 is the same as the method of carbonizing the molded body in the first embodiment, and descriptions thereof will not be repeated.

When the first molded body Y1 is carbonized, the core body V is thermally decomposed. In the thermally decomposing of the core body V, the amount of residual carbons is preferably less than 10 wt %. To achieve this, the core body V is made of thermoplastic resin such as polycarbonate, ABS (Acrylonitrile Butadiene Styrene copolymer) resin, styrene resin, polyethylene, or acrylic resin. When the core body V is thermally decomposed, cooling channels are formed in empty portions remaining after the core body V is thermally decomposed.

Next, fourth step S24 will be described.

Axle holes through which an axle passes are respectively formed in central portions of the first molded body Y1 and the second molded body Y2.

Through holes through which bolts connected to a hat part pass are respectively formed around the axle holes at the same interval on a concentric circle. The hat part is connected to a wheel.

Next, fifth step S25 will be described.

Upper and lower surfaces of the first molded body Y1 are coated with the liquid-phase phenol. The coating thickness is in a range of 0.1 to 2 mm. The second molded body Y2 adheres to the upper and lower surfaces of the first molded body Y1. The liquid-phase phenol protruding between the first molded body Y1 and the second molded body Y2 is removed.

As another method, solid-phase phenolic resin is sprayed onto the upper and lower surfaces of the first molded body Y1. The second molded body Y2 is placed on the upper and lower surfaces of the first molded body Y1, and is then pressed by the press to be heated by the heater provided at the press. While the solid-phase phenolic resin is melted, the second molded body Y2 adheres to the upper and lower surfaces of the first molded body Y1. The liquid-phase phenolic resin (a phase where the solid-phase phenolic resin is melted) protruding between the first molded body Y1 and the second molded body Y2 is removed.

When the first molded body Y1 and the second molded body Y2 adhere to each other, an adhesive layer to be described below is formed between the first molded body Y1 and the second molded body Y2.

Next, sixth step S26 will be described.

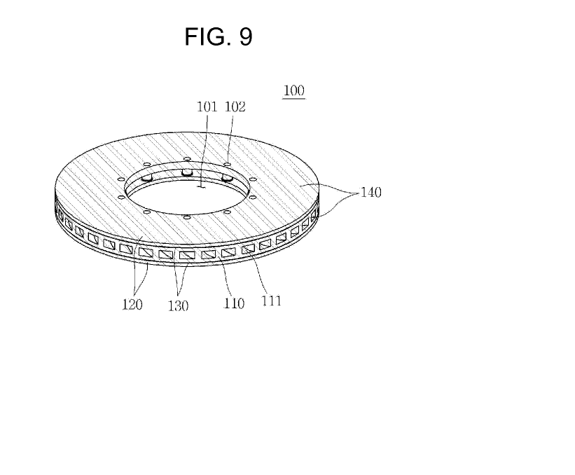

An outer peripheral surface of the first molded body Y1, cooling channels 111 (see FIG. 9) formed in the first molded body Y1, the second molded body Y2, and an adhering portion between the first molded body Y1 and the second molded body Y2 is brushed with the liquid-phase phenol by means of a brush, is sprayed with the liquid-phase phenol, or is dipped in a container filled with the liquid-phase phenol. The coating thickness of the liquid-phase phenol is in a range of 0.1 to 2 mm. The curing temperature is 200° C.

Next, seventh step S27 will be described.

Silicon is melted to be infiltrated into the first molded body Y1, the second molded body Y2, and the adhering portion between the first molded body Y1 and the second molded body Y2 that are coated with the liquid-phase phenol. A method of melting silicon to be infiltrated into the first molded body Y1, the second molded body Y2, and the adhering portion between the first molded body Y1 and the second molded body Y2 that are coated with the liquid-phase phenol is the same as the method of melting silicon to be infiltrated into the molded body in the first embodiment, and thus description thereof will not be repeated.

Next, eighth step S28 will be described.

The first molded body Y1 and the second molded body Y2 are ground by a grinder.

FIG. 9 is a diagram illustrating a carbon-ceramic brake disc manufactured by the method of manufacturing a carbon-ceramic brake disc according to the second embodiment of the present invention.

As illustrated in FIG. 9, the carbon-ceramic brake disc manufactured by the method of manufacturing a carbon-ceramic brake disc according to the second embodiment of the present invention includes a supporting layer 110, a friction layer 120, an adhesive layer 130, and an anti-oxidation coating layer 140. The supporting layer 110 and the friction layer 120 are composed of carbon fibers and ceramic matrixes other than the carbon fibers.

An axle hole 10 through which an axle passes is formed in a central portion of a carbon-ceramic brake disc 100. Through holes 102 through which bolts connected to a hat part pass are formed around the axle hole 10 at the same interval on a concentric circle.

The supporting layer 110 includes the cooling channels 111. A thickness of the supporting layer 110 is in a range of 20 to 50 mm. A composition of the supporting layer 110 includes SiC of 65 to 25 wt %, Si of 15 to 20 wt %, and C of 20 to 50 wt %.

A thickness of the friction layer 120 is in a range of 0.1 to 2 mm. A composition of the friction layer 120 includes SiC of 65 to 25 wt %, Si of 15 to 20 wt %, and C of 20 to 50 wt % that is the same as that of the supporting layer 110.

Since the composition of the supporting layer 110 and the composition of the friction layer 120 are the same, a thermal expansion coefficient of the supporting layer 110 and a thermal expansion coefficient of the friction layer 120 are the same. Accordingly, when the carbon-ceramic brake disc 100 is manufactured, due to a difference between the thermal expansion coefficients of the supporting layer 110 and the friction layer 120, cracks do not occur in the friction layer 120. The carbon fibers are randomly distributed in the supporting layer 110. The carbon fiber is formed such that the number of filaments each having a diameter of 7 μm in per bundle is in a range of 1K to 48K. A length of the carbon fiber is in a range of 25 to 30 mm.

The carbon fibers are randomly distributed in the friction layer 120. The carbon fiber is formed such that the number of filaments each having a diameter of 7 μm in per bundle is in a range of 1K to 48K. A length of the carbon fiber is in a range of 1 to 3 mm.

A thickness of the adhesive layer 130 is in a range of 0.1 to 1 mm. A composition of the adhesive layer 130 includes SiC of 50 wt %, Si of 45 wt %, and C of 5 wt %.

A thickness of the anti-oxidation coating layer 140 is in a range of 0.1 to 2 mm. The anti-oxidation coating layer 140 is composed of silicon burying cracks and silicon carbide generated in portions where the cracks do not occur.

As illustrated in FIG. 9, the anti-oxidation coating layer 130 is formed on an outer peripheral surface of the supporting layer 110, the cooling channels 111 of the supporting layer 110, upper and lower surfaces of the friction layer 120, and an outer peripheral surface of the adhesive layer 130.

Due to the anti-oxidation coating layer 130 without cracks, air does not come in contact with the outer peripheral surface of the supporting layer 110, the cooling channels 111 of the supporting layer 110, the upper and lower surfaces of the friction layer 120, and the outer peripheral surface of the adhesive layer 130. Accordingly, the outer peripheral surface of the supporting layer 110, the cooling channels 111 of the supporting layer 110, upper and lower surfaces of the friction layer 120, and an outer peripheral surface of the adhesive layer 130 are not oxidized.

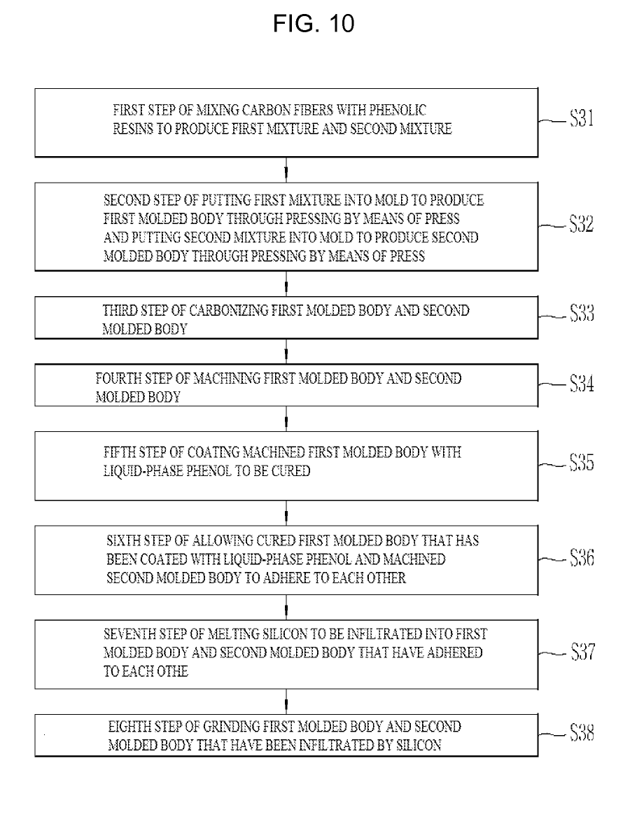

FIG. 10 is a flowchart illustrating a method of manufacturing a carbon-ceramic brake disc according to a third embodiment of the present invention. As illustrated in FIGS. 7(a), 7(b), 7(c), 8(a), 8(b), 8(c) and 10, the method of manufacturing a carbon-ceramic brake disc according to a third embodiment of the present invention includes first step S31 of mixing carbon fibers with phenolic resins to produce a first mixture X1 and a second mixture X2; second step S32 of putting the first mixture X1 into a mold M to produce a first molded body Y1 through pressing by means of a press P and putting the second mixture X2 into the mold M to produce a second molded body Y2 through pressing by means of the press P; third step S33 of carbonizing the first molded body Y1 and the second molded body Y2; fourth step S34 of machining the carbonized first molded body Y1 and second molded body Y2; fifth step S35 of coating the machined first molded body Y1 with liquid-phase phenol to be cured; sixth step S36 of allowing the cured first molded body Y1 after coated with the liquid-phase phenol and the machined second molded body Y2 to adhere to each other; seventh step S37 of melting silicon to be infiltrated into the first molded body Y1 and the second molded body Y2 that have adhered to each other; and eighth step S38 of grinding the first molded body Y1 and the second molded body Y2 that have been infiltrated by the silicon.

Meanwhile, the machined first molded body Y1 is not cured immediately after coated with the liquid-phase phenol in fifth step S35, but may be cured after adhering to the machined second molded body Y2. In such a case, the liquid-phase phenol used for coating the first molded body Y1 may be used to allow the first molded body Y1 and the second molded body Y2 to adhere to each other.

In the method of manufacturing a carbon-ceramic brake disc according to the third embodiment of the present invention, only the first molded body Y1 is coated with the liquid-phase phenol to be cured. Accordingly, the anti-oxidation coating layer is not formed on the outer peripheral surface of the adhesive layer and the upper and lower surfaces of the friction layer. However, when the brake is operated, since stress is mostly applied to the supporting layer, there is no problem even though the adhesive layer and the friction layer are oxidized to a certain extent. Excepting from the aforementioned description, the method of manufacturing a carbon-ceramic brake disc is the same as the method of manufacturing a carbon-ceramic brake disc in the second embodiment.

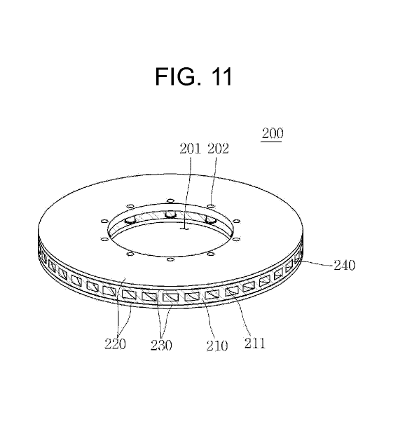

FIG. 11 is a diagram illustrating a carbon-ceramic brake disc manufactured by the method of manufacturing a carbon-ceramic brake disc according to the third embodiment of the present invention.

As illustrated in FIG. 11, the carbon-ceramic brake disc manufactured by the method of manufacturing a carbon-ceramic brake disc according to the third embodiment of the present invention includes a supporting layer 210, a friction layer 220, an adhesive layer 230, and an anti-oxidation coating layer 240.

An axle hole 201 through which an axle passes is formed in a central portion of a carbon-ceramic brake disc 200. Through holes 202 through which bolts connected to a hat part pass are formed around the axle hole 201 at the same interval on a concentric circle. The supporting layer 210 includes the cooling channels 211.

Thicknesses and compositions of the supporting layer 210, the friction layer 220, the adhesive layer 230, and the anti-oxidation coating layer 240 are the same as the thicknesses and compositions of the supporting layer 110, the friction layer 120, the adhesive layer 130, and the anti-oxidation coating layer 140 of the carbon-ceramic brake disc manufactured by the method of manufacturing a carbon-ceramic brake disc according to the second embodiment of the present invention, and thus descriptions thereof will not be repeated.

As illustrated in FIG. 11, the anti-oxidation coating layer 240 is formed on only the outer peripheral surface of the supporting layer 210 and the cooling channels 211. A thickness of the anti-oxidation coating layer 240 is in a range of 0.1 to 5 mm. The anti-oxidation coating layer 240 is composed of silicon filling in the cracks and silicon carbide generated in portions where the cracks do not occur.

Due to the anti-oxidation coating layer 240 without cracks, air does not come in contact with the outer peripheral surface of the supporting layer 210 and the cooling channels 211. Accordingly, the outer peripheral surface of the supporting layer 210 and the cooling channels 211 are not oxidized.

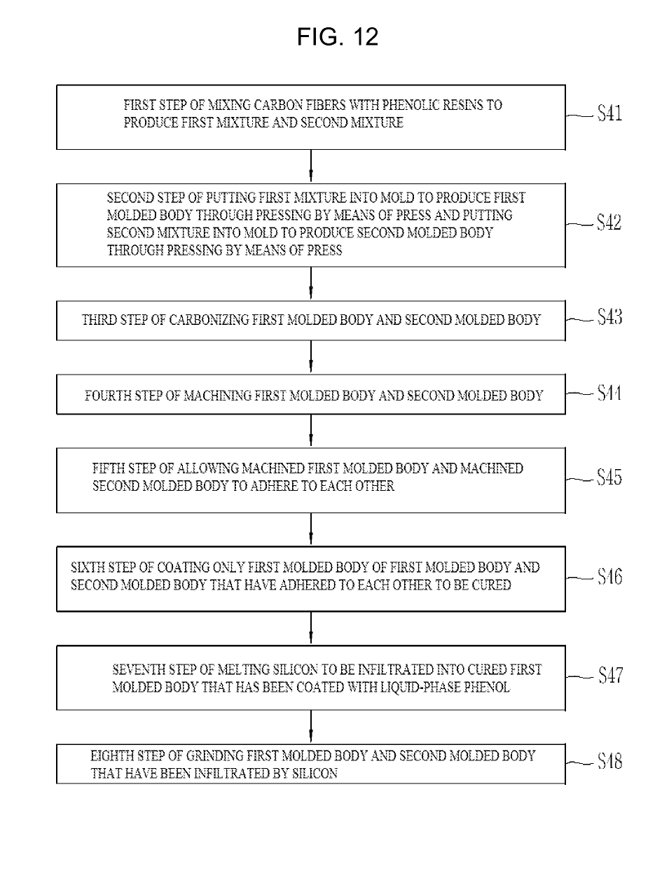

FIG. 12 is a flowchart illustrating a method of manufacturing a carbon-ceramic brake disc according to a fourth embodiment of the present invention.

As shown in FIGS. 7(a), 7(b), 7(c), 8(a), 8(b), 8(c), and 12, the method of manufacturing a carbon-ceramic brake disc according to the fourth embodiment of the present invention includes first step S41 of mixing carbon fibers with phenolic resins to produce a first mixture X1 and a second mixture X2; second step S42 of putting the first mixture X1 into a mold M to produce a first molded body Y1 through pressing by means of a press P and putting the second mixture X2 into the mold M to produce a second molded body Y2 through pressing by means of the press P; third step S43 of carbonizing the first molded body Y1 and the second molded body Y2; fourth step S44 of machining the first molded body Y1 and the second molded body Y2; fifth step S45 of allowing the machined first molded body Y1 and the machined second molded body Y2 to adhere to each other; sixth step S46 of coating only the first molded body Y1 of the first molded body Y1 and the second molded body Y2 that have adhered to each other to be cured; seventh step S47 of melting silicon to be infiltrated into the cured first molded body Y1 that has been coated with the liquid-phase phenol; and eighth step S48 of grinding the first molded body Y1 and the second molded body Y2 that have been infiltrated by the silicon.

In the method of manufacturing a carbon-ceramic brake disc according to the fourth embodiment of the present invention, the outer peripheral surface of the first molded body Y1 is coated with the liquid-phase phenol while the first molded body Y1 and the second molded body Y2 adhere to each other. Excepting from this, the method of manufacturing a carbon-ceramic brake disc according to the fourth embodiment is the same as that in the third embodiment. Further, a carbon-ceramic brake disc manufactured by the method of manufacturing a carbon-ceramic brake disc according to the fourth embodiment is the same as the carbon-ceramic brake disc manufactured by the method of manufacturing a carbon-ceramic brake disc according to the third embodiment, and description thereof will not be repeated.

1. A method of manufacturing a carbon-ceramic brake disc, comprising:
a first step of mixing carbon fibers with phenolic resins to produce a mixture;
a second step of putting the mixture into a mold to produce a molded body through pressing by means of a press;
a third step of carbonizing the molded body;
a fourth step of machining the carbonized molded body;
a fifth step of coating the machined molded body with liquid-phase phenol to be cured;
a sixth step of melting silicon to be infiltrated into the cured molded body that has been coated with the liquid-phase phenol; and
a seventh step of grinding the molded body that has been infiltrated by the silicon,
wherein in the sixth step, the cured portion that has been coated with the liquid-phase phenol is carbonized to cause cracks, and the cracks are filled with the silicon to be removed while the sixth step is performed.

2. The method of manufacturing a carbon-ceramic brake disc according to claim 1, wherein in the fifth step, the entire surface of the molded body is coated with the liquid-phase phenol, or only an outer peripheral surface of the molded body except for upper and lower surfaces thereof is coated with the liquid-phase phenol.

3. The method of manufacturing a carbon-ceramic brake disc according to claim 1, wherein in the fifth step, a surface of the molded body is brushed with the liquid-phase phenol by a brush, is sprayed with the liquid-phase phenol, or is dipped in a container filled with the liquid-phase phenol.

4. The method of manufacturing a carbon-ceramic brake disc according to claim 1, wherein in the fifth step, after carbon powders are added to the liquid-phase phenol, the molded body is coated with the liquid-phase phenol.

5. (canceled)

6. (canceled)

7. A method of manufacturing a carbon-ceramic brake disc, comprising:
a first step of mixing carbon fibers with phenolic resins to produce a first mixture and a second mixture;
a second step of putting the first mixture into a mold to produce a first molded body through pressing by means of a press and putting the second mixture into the mold to produce a second molded body through pressing by means of the press;
a third step of carbonizing the first molded body and the second molded body;
a fourth step of machining the carbonized first molded body and second molded body;
a fifth step of allowing the machined first molded body and the machined second molded body to adhere to each other;
a sixth step of coating the first molded body, the second molded body, and an adhering portion between the first molded body and the second molded body that have adhered to each other to be cured, or coating only the outer peripheral surface of the first molded body to be cured;
a seventh step of melting silicon to be infiltrated into the first molded body, the second molded body, and the adhering portion between the first molded body and the second molded body; and
an eighth step of grinding the first molded body and the second molded body that have been infiltrated by the silicon.

8. A carbon-ceramic brake disc, comprising:
a supporting layer;
a friction layer that adheres to upper and lower surfaces of the supporting layer;
an adhesive layer that is formed between the supporting layer and the friction layer; and
an anti-oxidation coating layer that is formed on an outer peripheral surface of the supporting layer, a surface of the friction layer, and on an outer peripheral surface of the adhesive layer, or is only formed on an outer peripheral surface of supporting layer,
wherein the anti-oxidation coating layer includes silicon filling cracks to remove the cracks and silicon carbide generated in portions where the cracks do not occur.

9. (canceled)

10. (canceled)

11. (canceled)
